(19) United States
(12) Patent Application Publication
(10) Pub. No.: US 2018/0089718 A1
(43) Pub. Date: Mar. 29, 2018

(54) A METHOD, SYSTEM AND SOFTWARE APPLICATION FOR PROVIDING CONTEXT BASED COMMERCIAL INFORMATION

(71) Applicant: C CONJUNCTION AB, Mölndal (SE)

(72) Inventor: Omid RAISI, Mölndal (SE)

(73) Assignee: C CONJUNCTION AB, Mölndal (SE)

(21) Appl. No.: 15/559,279

(22) PCT Filed: Mar. 17, 2016
(86) PCT No.: PCT/SE2016/050225

§ 371 Date: Sep. 18, 2017

(30) Foreign Application Priority Data
Mar. 18, 2015 (SE) 1550327-9

(51) Int. Cl. G06Q 30/02

(52) U.S. Cl. CPC G06Q 30/0267; H04L 67/306; H04W 76/02

(57) ABSTRACT

A method for providing context based commercial information, as well as a corresponding system and software application. The method includes establishing of a voice communication session, such as a telephone call, between a first party using a mobile communication device, such as a Smartphone, and at least one other party using a remote communication device via a communications network. Information associated with the voice communication session is received at a remote server, including at least identification data of the parties participating in the voice communication session and audio data associated with the communication session, and is analyzed to generate customized commercial information, which may then later, at any time be sent to the mobile communication device.

### TECHNICAL FIELD

The present invention relates to a method for distribution of customized commercial information to mobile communication devices, a software application and a system thereof.

### BACKGROUND

Handheld communication devices, such as e.g. smart phones, are increasingly becoming more powerful, and are probably the preferred devices to use for communication with other people. The increased power and functionality of the hand held communication devices, such as smart phones, have simplified and enriched communication possibilities, and users may choose to communicate by voice, video or text. They have become an essential part of our everyday life and it is hard to imagine a decrease in the number of users.

It is also known to use such mobile communication devices for simultaneous call sessions and data transfer. For example, US2014/0106720 discloses a method by means of which a data communication session can be established simultaneously with a telephone call between two parties in two separate telephone applications. The method allows a calling party to setup a data communication session with the called party without needing to identify the called party twice, once for the purpose of setting up the telephone call and once for identifying the party in the data communication session. However, it might be cumbersome for a user to switch between two separate applications.

Advertising is essential part of industry, business entities have to make sure that customers are aware of their products, and good advertisements are often rewarded with an increase in revenue. Because of the on-going development of handheld communication devices, and their constant increase in popularity it makes for a good potential advertisement market for companies.

However, distributing advertisements with random context is seldom the most efficient way to go, and might in severe cases even damage brand names and decrease revenue.

US2010/0241664 discloses a method where a calling party can receive relevant visual information about the called party on their phone, thus allowing for an integrated solution of data transfer and a telephone call. The relevant visual information received by the calling party is based on a variety of factors including geographic location, time of day and also speech recognition if the user is speaking to an interactive voice response system (IVR), which may trigger if the user mentions certain key-words. However, this instantaneous presentation of visual information is complicated to achieve in practice, and has limited use in practice. There is also a substantial risk that erroneous or useless information is presented.

There is therefore a need for a software application offering a more convenient way to communicate data between two parties calling each other and more reliable and less limited information received by the calling party.

There is also a need for a more efficient identification and presentation of data for users using mobile telephones. There is still further a need for more efficient control of automated apparatuses, such as household appliances, communicating with mobile communication devices.

### SUMMARY

In view of the above it is a general object of the present invention to provide a software application for mobile communication devices, a method and a system which alleviates at least some of the above-discussed problems. In particular, it is an object to obtain more relevant and useful personal data in order to make it possible for e.g. business entities to provide better and more customized content such as e.g. advertisements to consumers.

According to one aspect of the invention there is provided a software application for a mobile communication device, residing on a computer-readable medium and comprising computer program code for:

establishing a voice communication session between a first party using said mobile communication device and at least one other party using a remote communication device via a communications network, the voice communication session being established with said at least one other party utilizing a phone number associated with the at least one other party;

sending information associated with the voice communication session to a remote server, the information comprising at least identification data of the parties participating in the voice communication session and audio data associated with the voice communication session, the audio data being used to generate customized commercial information for the parties participating in said voice communication session after termination of the voice communication session; and

receiving the customized commercial information in said mobile communication device after termination of the voice communication session.

The mobile communication device may for example be a handheld device, such as e.g. a smart phone, a personal digital assistant (PDA), a tablet computer or any other mobile computing device capable of handling both voice and data communication.

The computer readable medium is preferably a non-transitory computer-readable storage medium, such as a program storage device readable by a machine, and the software application is a program of instructions executable by the machine to perform the defined method steps.

The communications network may be any communication network for transfer of voice or data, such as GPRS, 3G, GSM, WiMAX, 4G, VoLTE etc. The same communication network may be used for establishing the voice communication session and for transferring of data, but it is also possible to use different communication networks, such as using GSM for the voice communication and WiFi for the data communication. The voice communication may also go through the remote server instead of a standard mobile communications network provided by a telephone operator, for example in the case of VoIP communication. Instead of just information associated with the voice communication session being sent to the remote server, the whole conversation may be directed through the server. The remote server may then also serve to mediate the voice communication session between mobile communication devices. Instead of just generating customized commercial information based on the audio data associated with the communication session.

The “audio data associated with the voice communication session” is in the present context to be construed broadly, and may relate to an audio file comprising the entire voice communication, or parts thereof. However, it may also be text data extracted from said audio, e.g. obtainable by speech recognition software. Further, such text data may comprise the entire speech, or extracted parts thereof, such as certain keywords or key phrases.

Additionally, the extracted parts, such as certain keywords or key phrases may be used to block conversations and/or track phone calls where certain keywords and/or key phrases have been identified. This could perhaps be used to track company/business secrets being spoken over telephones or other communication devices. For example, this may be used to prevent company/business secrets and/or protected information from being discussed over unsecured communication paths. This may be realized by issuing a warning to the parties participating in the current communication session and offering them encryption or to continue the session over a secure application.

As identification data it is possible to use a phone number, or other data useable to identify the user such as e.g. e-mail addresses, device ID, IP-address, various user accounts, voice recognition, etc. The user may for example link the software application to his e-mail account or some social network account like for example Facebook or Google+. Voice recognition may be beneficial to use when identifying data across several voice-chat programs and linking it to one user. Furthermore voice recognition may be used to link a specific user to an already existing profile if the user's other identification data would be changed, such as e.g. his/her telephone number or device. Moreover the voice communication session may be a video communication session comprising both audio and video transfer.

The present invention is based on the realization that there is a big amount of information communicated between parties communicating over hand held devices that are very relevant for, e.g. business entities, authorities, organizations, etc., for use e.g. in marketing campaigns. As an example one could think of the situation where one party in the voice communication session is calling a computer repair-shop regarding a malfunction. During their conversation it is concluded that he or she is in need of a certain hardware or software product, this information would be immensely valuable for one or more companies selling this particular product. At the same time it would be beneficial for the party in need of these parts to receive relevant offers and/or advertisements directed towards his or her particular needs and only those. Moreover the information may be used in combination with other data, e.g. third party data, associated with the party, the other data being collected from other sources e.g. from online activities such as web-browsing.

It is possible to use the information obtained from the voice communication for various ends in connection with use of the telephone application, for presentation of relevant content in a window of telephone application etc. Thus, it is possible to generate more accurate customized content, such as advertisement and relevant product features. However, additionally or alternatively, it is possible to use the information obtained from the voice communication to similar ends when using other applications and programs, such as when using browsers for web surfing on the same device or when using other devices.

It is also of interest to determine particular areas of interest related to the user, and to customize offers and advertisements based on this information.

The information associated with the voice communication session can be stored locally on the associated local device as a general file comprising the audio data associated with the voice communication. The general file might also comprise other relevant data such as e.g. which number was dialed, current or historical geographic location, presence status, time of day, implicitly learned patterns. The information stored on the local file may then be analyzed afterwards to control the content of advertisements and the like towards the party or parties associated with the information stored. The general file may also be stored remotely on e.g. a remote server.

The information acquired during conversation may also be stored locally as a “talkie” i.e. a similar file to a “cookie” which is created when visiting a website while the “talkie” is created when a call is made. Thus there is a corresponding “talkie” or “talkie file” stored remotely on for example the remote server which may be analyzed afterwards. The “talkie” and/or the “talkie file” may comprise the full conversation as a sound file or a transcribed text of the conversation, or relevant parts thereof. The “talkie” may also comprise other relevant data such as e.g. which number was dialed, current or historical geographic location, presence status, time of day, implicitly learned patterns. The “talkie” may later be analyzed and used to generate customized advertisements. The customized advertisements may be displayed during or after the voice communication session. Further, the customized advertisement may be presented or displayed to the user outside of the application, for example while browsing websites and/or on other devices associated with the user, e.g. personal computers. Preferably, the complete “talkie”, audio or speech file may be analyzed, i.e. the whole conversation is analyzed and conclusions are drawn based on this and not only on certain identified keywords, in order to get a richer understanding of the user's interests and needs.

The “talkie” may be preferably analyzed locally at the clients. This can be beneficial if a user faces problems associated with roaming, and the increased costs that may follow larger data transfers. The analysis of the “talkie” may then be sent to the remote servers, alternatively the data may be sent to the remote server before analysis.

Furthermore, in one exemplary embodiment, one or both mobile communication device, i.e. one of or each client, may store and/or analyze only the part of the voice communication spoken directly in to the microphone and/or headset of that device. In this example, only one part of the communication is stored and analyzed by the specific client, preferably the part of the communication originating from that specific client. This is beneficial when trying to avoid problems with so-called “overlapping speech”, which is a common problem within the field of speech recognition.

Moreover, the “talkie” may comprise identification data, such as e.g. a phone number, e-mail, device ID, IP-address, various user-accounts, voice recognition, etc. As discussed previously, voice recognition may be beneficial to associate a certain user with a stored “talkie” in case of that user changing his phone number or e-mail accounts, using voice recognition, the correct user may be linked to the previously stored “talkie” or “talkie”-profile.

Even further, the voice recognition data associated with a certain “talkie” or “talkie”-profile may improve security by verifying the user initiating a communication session by cross-referencing it to voice recognition data stored in the associated “talkie” or “talkie”-profile.

The general file, “talkie” or “talkie file” may be complemented with tags or marks. The tags or marks may be manually or automatically added to the general file, “talkie” or “talkie file”. The tags or marks may comprise details of particular communication sessions or conversations. The tags or marks may then be used to acquire a quick overview of a conversation and the contents of it. As an illustrative example one can think of a business entity making a call to a customer through a software application as previously described, thus creating a “talkie”, the business entity may then attach or complement this created “talkie” with tags or marks in their customer relationship management (CRM) system.

Further, “talkies” may create “cookies” for other systems. A voice communication session resulting in a “talkie” may also generate a “cookie” for internet-based systems.

Even further, “talkies” created from a voice communication session may be used in combination with “cookies” associated with the same user but generated from other sources. The combination of “talkies” and “cookies” may trigger events automatically or directly during the voice communication session and/or update logs in the system. For example, data comprised in a previously created “cookie” may be used in combination with a “talkie” to improve the analysis of the data stored in the “talkie”.

Moreover, “talkies” may be combined and cross-referenced with multiple sources of user-information and/or personal data, such as e.g. third party sources, chat-conversations, text-messages, “cookies”, web-profiles etc. The combination can be used to improve marketing efforts.

The analysis may comprise identification of what the conversation is about, who the other party is, when the call occurred, the user's geographical position when making the call, etc.

Furthermore, the inventors have realized that there is a need for someone to provide a complete communication solution for handheld communication devices, such as e.g. smart phones, personal digital assistants (PDA), tablet computers or any other mobile computing devices. With the invention all of the needed functions are gathered in the same program or system. Hereby, the user may communicate more freely, and also obtain relevant graphical information during ordinary telephone conversations.

The analysis and speech recognition preferably occurs in real time during the voice communication session, thereby obviating the need for storing audio files of the conversations, and limiting the amount of data needed to be stored.

It is also possible to, based on said speech recognition, to provide a voice activated assistance service from the remote server. For example, this service may be requested by uttering one or several specific activation words or commands, whereby the service responds with follow up questions, or performs the requested act. The service may e.g. be used to display a certain web page, to be displayed on the screen of either or both of the communication devices, to get back with factual data in response to a certain question, or the like. Preferably, this service is provided as a common resource, accessible by both parties involved in the voice communication session. In particular, this service may be provided during a voice communication session with another party.

In one exemplary embodiment of the invention, the software application further comprises means for transferring data between the parties participating in the voice communication session while maintaining the voice communication session. This means that the parties can talk to each other and transfer images or data files between each other without interrupting the voice communication session. This could be useful when a user is talking to a remote user and the first user needs to share a document to the remote user for whatever reason. Furthermore, the software application may comprise means for a user or party to sign documents or provide authorization within the software application. This could also be performed during a voice communication session. If, for example, the calling party is offered a deal requiring a signature or authorization this could be performed within the same application, and without ever leaving the voice communication session.

In one exemplary embodiment of the invention, the software application further comprises means for establishing a data communication session between a mobile communication device and a remote device with network capabilities. Furthermore, the remote devices may be controlled by the user using the mobile communication device. For example, the remote device may be any household appliance, such as, e.g. a refrigerator with network and processing capabilities. The aforementioned refrigerator may communicate data to the mobile communication device; the data may for example comprise information regarding items contained in the refrigerator. The information could be related to the expiration dates of certain items, or possibly a reminder to the user using the mobile communication device to acquire certain missing items. Advantages with this example embodiment are, among other advantages, time-savings due to the fact that the user does not need to be near the remote device to receive information. To continue with the example discussed earlier with the refrigerator, the user can check his grocery shopping needs away from home in real-time. Moreover there is a money-saving property involved in this example, due to the minimization of purchasing of unnecessary groceries, due to guessing of needed items, and the following discard of unused expired groceries. The data communicated between the mobile communication device and the remote device may further be used for providing the user of the mobile communication device with commercial offers and advertisements based on the communicated data.

In one exemplary embodiment of the invention, the software application further comprises means for gathering health data from sensors within the mobile communication device or external sensors and sending the gathered health data to the at least one other party participating in the voice communication session. There is a variety of health-monitoring sensors compatible with mobile communication devices. Thus, it would be advantageous to provide means for gathering health data, such as, e.g. heart rate, blood pressure, body temperature etc. and then enabling transfer of this data to at least one other party participating in the voice communication session. For example, it would be beneficial if the at least one other party was a doctor which a user called regarding some health issue, the doctor could then gain immediate access to vital data to allow for faster and more accurate treatment. Moreover, the health data can also be used in sporting or athletic scenarios where a coach can do remote monitoring/coaching of athletes.

In another exemplary embodiment of the invention, the software application further comprises means for automatically sending data from the mobile communication device to the at least one other party participating in the voice communication session when the phone number associated with the at least one other party is an emergency phone number. This embodiment provides an advantage in emergency situations in which a user might be in shock or under a lot of stress and not able to properly or in a timely fashion communicate his or her location. Data gathered from internal or external sensors of the mobile communication device, the data comprising location information is automatically sent to the other party in case of emergencies, i.e. when calling an emergency number. Thus, in situations when fast dispatching is of great importance, the location of the mobile communication device is sent immediately and help can be sent a lot quicker than it would be without this functionality or property. Additionally, the data gathered from the sensors may further comprise health data of the user, such as, e.g. pulse, blood pressure, etc.

In an additional exemplary embodiment of the invention, the software application comprises a profile associated with the user. The profile may be changed and updated by the user and displayed on the at least one other parties mobile communication device, during a communication session or offline, i.e. when no communication session is currently taking place. Thus, user profiles may be accessed remotely by other users of the software application or by administrators of the software application.

For example, the profile may comprise a pre-set emergency profile which can carry health data, past medical history, or the like, and which can e.g. be accessible by emergency services. This can inter alia enable medical staff to be better prepared when meeting emergency patients.

According to a second aspect of the invention there is provided a method for providing context based commercial information, said method comprising:

establishing a voice communication session between a first party using a mobile communication device and at least one other party using a remote communication device via a communications network;

receiving information associated with the voice communication session at a remote server, said information comprising at least identification data of the parties participating in the voice communication session and audio data associated with the communication session;

analyzing said received information;

generating, based on said analyzed information customized commercial information;

sending said generated customized commercial information to the mobile communication device.

In one exemplary embodiment of the invention, the method further comprises storing said received information in a profile associated with at least one of said parties.

Further effects and features of this second aspect of the present invention are largely analogous to those described above in connection with the first aspect of the invention.

According to a third aspect of the invention there is provided a system for providing user customized commercial information, which system comprises:

means for establishing a voice communication session between a first party using a mobile communication device and at least one other party using a remote communication device via a communications network;

means for establishing a data communication session while maintaining the voice communication session; and

server means for receiving information associated with said voice communication session, the information comprising at least identification data of the parties participating in said communication session and audio data associated with the voice communication session, said audio data being useable to generate customized commercial information for at least one of the parties participating in said communication session after termination of said communication session.

In one example embodiment of the invention, the system further comprises means for storing said received information. The stored information may be stored together with a profile associated with at least one of said parties.

Further effects and features of this third aspect of the present invention are largely analogous to those described above in connection with the first aspect of the invention.

According to a further aspect of the present invention, there is provided a method for controlling the operation of an automated apparatus connected to a communication network, via a mobile communication device also connected to said communication network, comprising the steps:

receiving at the mobile communication device first data acquired by the automated apparatus;

retrieving second data from the mobile communication device; and

generating, based on said first and second data, a proposed action for the operation of the automated apparatus.

The steps of receiving first data and retrieving second data can be performed in any order, and also simultaneously.

The method is preferably realized as a software application on a computer readable medium, and preferably a non-transitory computer-readable storage medium, such as a program storage device readable by a machine, and the software application is preferably a program of instructions executable by the machine to perform the defined method steps.

This method is preferably implemented in the same software application as discussed in the foregoing, and combined with the method and system already discussed. However, this method may also be independent, and implemented as a separate software application, and consequently useable as a separate method and system.

Many apparatuses used e.g. in an ordinary household are today automated and accessible via communication networks. It has now been found by the present inventor that the operation of such apparatuses can be improved by using data retrievable from a user's mobile communication device, such as a smart phone.

At least one, and preferably both, of said first data and second data is preferably sensor data obtained by a sensor. The sensor(s) may be integrated sensors in the automated apparatus and/or the mobile communication device. However, the sensor(s) may also be arranged in separate units, and e.g. arranged to communicate sensor data to the automated apparatus and/or the mobile communication device by wired or wireless communication, such as bluetooth. For example, the sensors may be arranged in wearable units, such as being integrated in clothing, arranged in watches or bracelets, etc.

For example, the sensor(s) in the mobile communication device, or connected to the mobile communication device, may be a position sensor, such as a GPS sensor, measuring the geographical position of the mobile communication device. Further, the sensors may be accelerometers and the like, e.g. usable to sense various health related parameters, such as physical activities of the user, e.g. counting the number of steps taken during a certain period of time, calories burnt over a certain time, etc. Other health related parameters that can be measured are e.g. blood pressure, body temperature, pulse rate, breathing rate, spirometry data, etc.

However, instead of sensor data, the second data may additionally or alternatively be related to data retrieved in other ways, such as data obtained from an electronic calendar application in the mobile communication device.

The automated apparatus is preferably controllable from the mobile communication device. For example, such control can be provided by entering and sending text instructions to the automated apparatus, by voice commandos, or by operation of a dedicated control interface, such as a virtual dashboard or the like.

The proposed action may be provided as a suggestion, presented to the user of the mobile communication device as a text or audio message. It may also be sent as instructions to the automated apparatus, either automatically or upon confirmation by the user of the mobile communication device.

The automated apparatus is preferably at least one of a household appliance, a home security alarm system and a central heating system. In case of household appliances, the automated apparatus is preferably a major appliance, i.e. a white goods appliance, such as a stove, a refrigerator or the like.

In one exemplary embodiment, the automated apparatus is a refrigerator. The refrigerator may comprise sensors to keep track of the content in the refrigerator, and may automatically issue an alarm, a suggested shopping list or the like whenever a need is detected. However, by interaction with mobile communication device, this functionality may be improved by further taking into consideration additional data obtainable from the mobile communication device. For example, calendar data may be used to determine how much time the user will spend away from home in the near future, and adapting the suggested shopping list accordingly. Further, sensor data indicating the amount of physical exercise in the near past may be used to calculate the need for various supplies more accurately.

In another exemplary embodiment, the automated apparatus is a home security system, which is automatically switched on and off at various times. By interacting with the mobile communication device, the control of this system may be further improved e.g. by taking into account the physical location of the user, i.e. the physical location of the mobile communication device. For example, this may be used to automatically switch on the security system whenever the user/mobile communication device is more than a certain predetermined minimum distance away from the home. Additionally or alternatively, calendar data from the mobile communication device may be used to activate the home security system during planned trips, such as vacations, business trips etc.

In a similar way, data from the mobile communication device may be used to improve operation of e.g. heating systems, such as a central heating system or one or more heaters, air conditioning systems, etc. so that the power consumption can be lowered, and the requested indoor temperature is still provided whenever the user is at home.

In case there are more than one person living at the same place, the second data may be obtained from more than one mobile communication device, and assembled together in the automated apparatus, in one of the mobile communication devices, or in a separate control unit, such as a remote server.

Further, the control of more than one automated apparatus may be coordinated together, to be accessible through a common interface, and to be controlled from a common control unit. For example, many automated apparatuses may be controlled from a control unit which may be called from the mobile communication unit by a single call session, and which can obtain the data necessary from the mobile communication device by simultaneous data transfer during the call session.

### BRIEF DESCRIPTION OF THE DRAWINGS

These and other aspects of the present invention will now be described in more detail, with reference to the appended drawings showing some example embodiments of the invention, wherein:

FIG. 1 is a schematic block representation of a communication system according to one example embodiment of the invention.

FIG. 2 is an illustration of an application selection screen according to one example embodiment of the invention.

FIG. 3 is an illustration of the user interface of the software application according to one example embodiment of the invention.

FIGS. 4-11 are illustrations of various detailed interface views of a software application according to embodiments of the invention.

### DETAILED DESCRIPTION

In the following description, the present invention is mainly described with reference to a smart phone. However, the invention may also be applied to other mobile communication devices such as tablets and laptops.

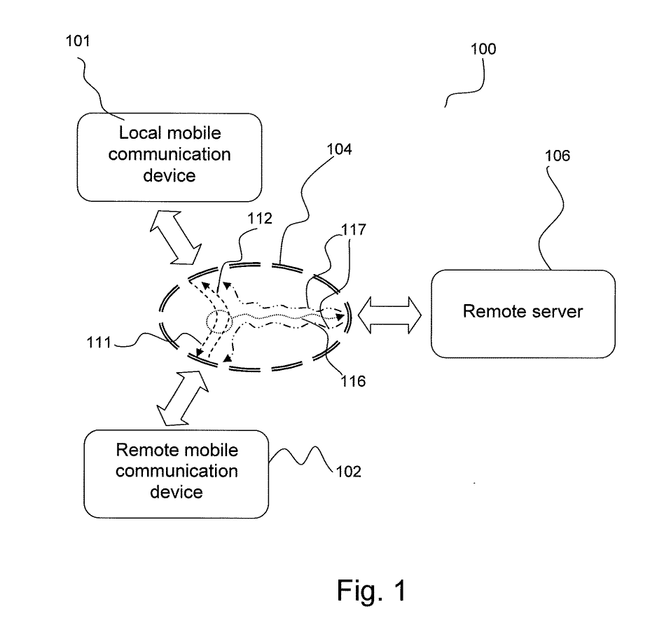

FIG. 1 illustrates a schematic block representation of a communication system 100 according to an exemplary embodiment. The communication system comprises a local mobile communication device 101, such as a smart phone, and a remote communication device 102, both being connected to a network 104. The remote communication device may also be a mobile communication device, such as another smart phone, but may also be a stationary communication device.

The local mobile communication device 101 may establish a voice or video communication session with the remote mobile communication device 102, via the network 104. In this example only one remote mobile communication devices 102 is illustrated but it may be a plurality of remote mobile communication devices 102 participating in the same communication session.

Further, data transfer may occur between the two communication devices, as is illustrated by dashed arrows 111 and 112.

Further, data communication is established from at least one of the communication devices to a remote server 106, so that data 116 associated with the voice or video communication session is sent to the remote server 106. The data 116 comprises at least identification data of the parties participating in the communication session and audio data associated with the communication session. This audio data may comprise all or part of the voice session, either as audio, or as text generated by a speech recognition software.

The data 116 is then analyzed and used to generate customized commercial information 117 after termination of said voice communication session. The customized commercial information 117 may then be sent to the parties associated with the communication session, either separately, or during other communication sessions. The customized commercial information may be provided either by the remote server, or by other servers connected to the communication network.

The customized commercial information 117 may be displayed during or after the voice communication session. Additionally or alternatively, the customized commercial information 117 may be presented or displayed to the user outside of the software application, for example while browsing websites and/or on other devices associated with the user, e.g. personal computers. Moreover, data 116 may be combined and cross-referenced with multiple sources of user-information and/or personal data, such as e.g. chat-conversations, text-messages, “cookies”, web-profiles etc. The combination can be used to improve marketing efforts and/or to generate customized commercial information 117 in the manner described earlier.

In an illustrative example, the remote communication device 102 may be a towing company and the local mobile communication device 101 belongs to a person in need of a tow-service. During the communication session it is clear from the context that the local mobile communication device user's car-engine has malfunctioned. The information data 116 analyzed could for example be used to provide the user with information about auto-mechanics nearby and current offers, or possibly information about dealers selling spare parts. Subsequently, the user can also be provided with advertisements related to car dealers and new cars.

The information data 116 may be stored in storing means in a profile of at least one of the parties associated with the communication session 111, 112. Alternatively or additionally, the information data may be stored as a profile in the remote server, for use in subsequent customization of advertisement and the like. The profile data may be continuously updated over a number of call sessions, thereby providing a richer understanding of the user's needs and interests.

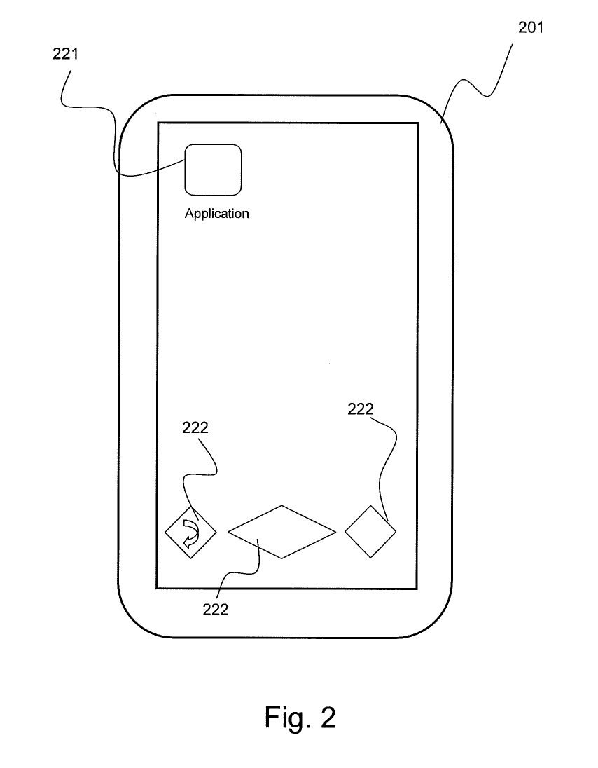

FIG. 2 is an illustration of an example of an interface of the mobile communication device 101, here represented as a touch screen of a smart phone 201. FIG. 2 illustrates the interface when the above-discussed software application has not been started. The software application according to an example embodiment of the invention is represented by an application icon 221. The buttons or icons 222 are standard example buttons often present in screen interfaces on mobile communication devices.

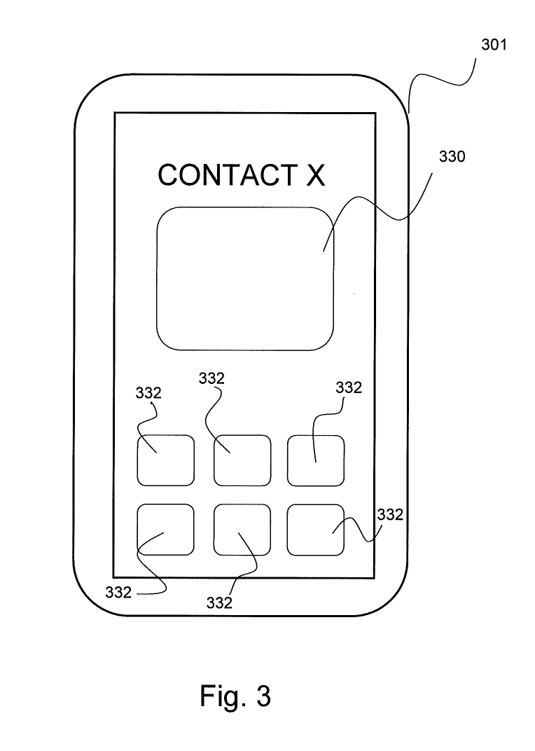

An example of the user-interface associated with an active communication session, where the button 221 has been operated and the software application according has been started, is illustrated in FIG. 3. The software application functions as a conventional telephone application, but includes a number of additional features and functions, as has been explained in the foregoing, and as will also be exemplified in the following.

After selection of which contact to initiate a communication session with, in this example, contact x, the contacts profile information or other relevant data is presented in a data window 330. The profile information may comprise a profile picture, current personal information or any other by a user selectable information. In one embodiment, any user of the system may prepare a special information page to be displayed during a call session. This may be referred to as “call page”. For example, the tow-service in the above-discussed illustrative example may prepare a call page comprising general information about the company, specific current offers, etc. It is also possible to display pages generated by previously identified and analyzed call sessions, e.g. based on the previously discussed talkies. Moreover, the “call page” may be modified by a user to display, e.g. special offers, general information, advertisements, etc. Further, the “call page” may comprise service functions for example in the form of icons which are displayed on the other party's device and selectable by the other party, e.g. as an alternative to number selection/dial selection.

Standardized call pages may also be provided, which will be displayed to other calling parties. This is particularly suitable for private users. Such call pages may allow and be used for the other caller to send content, such as a document, along with a voice message when a call is not answered. Both content and voice mails can later be accessed in the dialer application's offline mode. Furthermore, by combining voice messages with content sharing, when calls are not answered, the benefit of the conventional voice mail will be even greater

The user-interface image is illustrated on a generic smart phone 301 in this example but is not limited to smart phones. Furthermore, the user-interface may comprise additional buttons or windows, such as the schematically illustrated functional buttons 332 or icons, with functions e.g. as described in more detail in the following exemplary embodiments. The buttons 332 or icons may for example activate an image transfer function, or any file transfer function. Moreover, the buttons 332 may comprise an authorization/signature function, sending of location data, sending of health data, invitation of other application users to the communication session for a conference-call type communication session. The buttons 332 may further comprise enablement of screen-sharing so that all participating parties are viewing the same image, video or browser page.

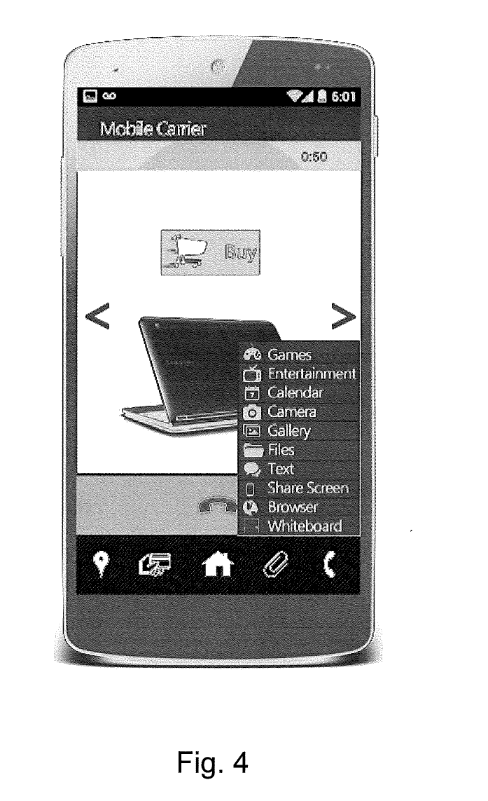

Various detailed interface views, and thereby related functions and possibilities, will now be discussed with reference to FIGS. 4-12.

In the software application and interface of FIG. 4, a display window is provided in the centre, and information about the other party of the call session is provided at the top, just as in the previous embodiment. The display window may comprise several different views, and the user may switch view by e.g. pressing arrows at the sides, sweeping with the finger to the sides or upwards/downwards, or in other feasible ways.

In addition, a number of buttons are provided at the bottom of the screen. The five buttons are here, starting from the left, related to:
Position data;
Transactions and payment;
Home;
Forwarding of files; and
Telephone.

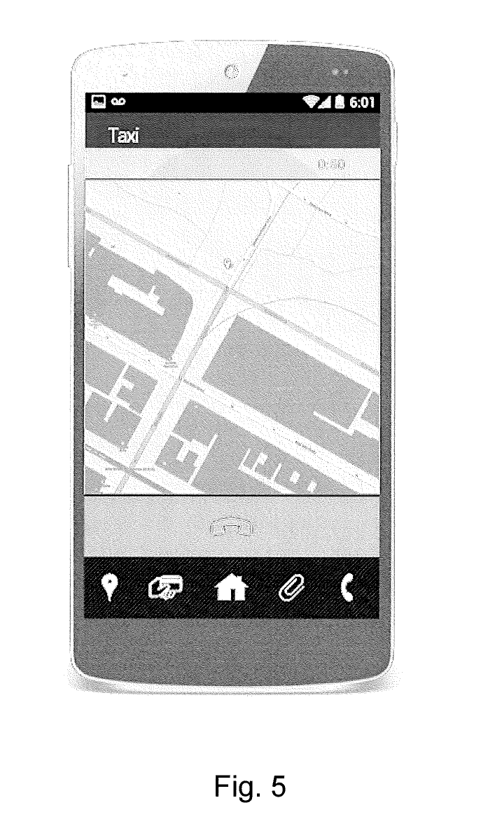

The position data button may when activated immediately forward the position data for the communication device, obtained e.g. from a GPS sensor, to the other party. This is e.g. very useful when there is a need to inform the other party of the current position during a call, e.g. when trying to find each other, talking to a tow service, calling an alarm service, etc. When activated, position data may be forwarded once, but may also be continuously forwarded to the other party. It may also be used to display the current position of a taxi that is on its way, a tow car, an ambulance, etc. This may then be displayed on a map on the receiving communication device, as illustrated in FIG. 5.

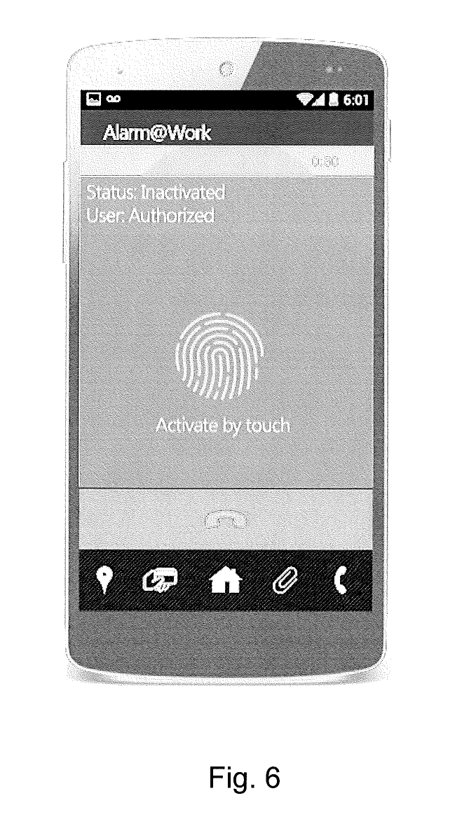

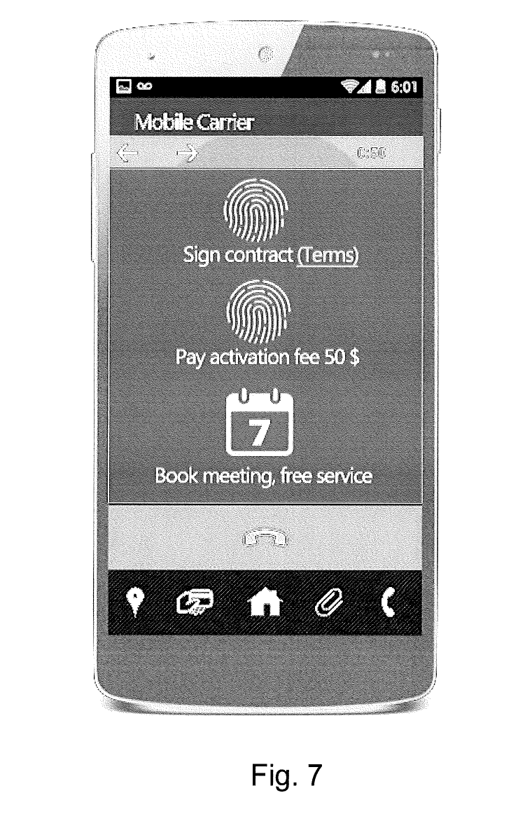

The transaction and payment button may be used to provide payment, authentication, etc during a call session. This can e.g. be made by finger print recognition, voice recognition, etc, as is per se known in the art. This is schematically illustrated in FIG. 6, where the display shows an authentication prompter, which is activated by pressing a finger on the fingerprint scanner, whereby authentication is obtained. The location of the finger print scanner is dependent on the device used. Authentication and transaction verification can be performed in the client devices, or via trusted third parties, as is per se known in the art. A further illustration of how signing a contract and/or payment of a fee can be obtained during a call session is illustrated in FIG. 7. Here, the upper part of the display window relates to agreement on a contract, and the user may select to first review the contract by pressing the link “Terms”, by switching windows, etc. Payment may also be performed in a similar way, e.g. by finger print recognition. Further, it is here also possible to synchronize two or more calendars to find suitable meeting possibilities, as illustrated at the lower part of the display window. Such possibilities may however also be accessed in other ways.

The home button may be used to access a predetermined starting page.

The forwarding of files button may be used for many various functions, and may preferably generate a pop-up menu for further selection. Such a pop-up menu is illustrated in FIG. 4. In the exemplary embodiment, the pop-up menu comprises the following choices:
Games
Entertainment
Calendar
Camera
Gallery
Files
Text
Share screen
Browser
Whiteboard

However, such various options may also be accessed in other ways, instead of having a pop-up menu. Further, the items of this particular illustrated menu are only given by way of example, and many other possibilities are feasible in addition or as alternatives.

Games may here e.g. relate to games that when selected becomes active at both communication devices participating in the call session, thereby enabling the users to play games during the call.

Entertainment may be used for displaying various entertainment acts at both communication devices simultaneously during the call session, such as sport events that may be acquired as pay-per-view and other streaming media content.

Calendar may be used to synchronize the calendars of both communication devices, in order to find suitable meeting possibilities etc.

Camera may be used to share camera views and pictures taken or films being recorded during the call sessions, whereas Gallery may be used to share or transfer previously taken pictures or videos.

Files may be used to share or transfer other files stored on the communication device.

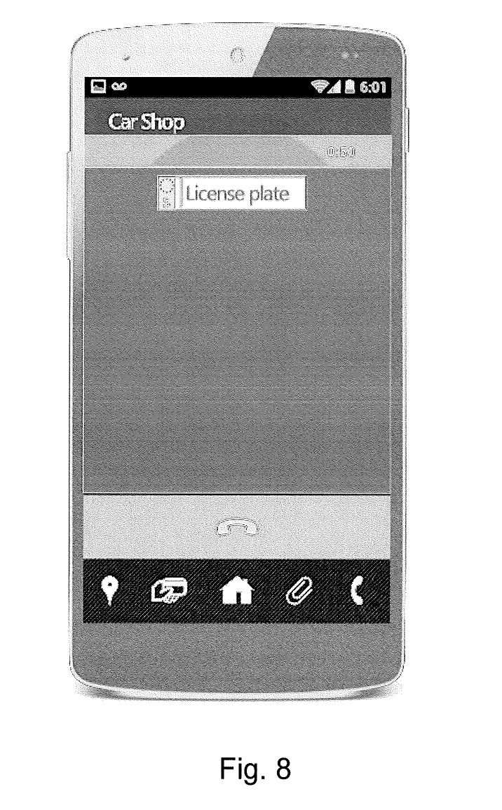

Text may be used to write text messages that are transferred during the call sessions. For example, it may be used to text data that is requested by the other user, such as the registration number of a car, a telephone number to another party, a social security number, etc. Such a mode is schematically illustrated in FIG. 8.

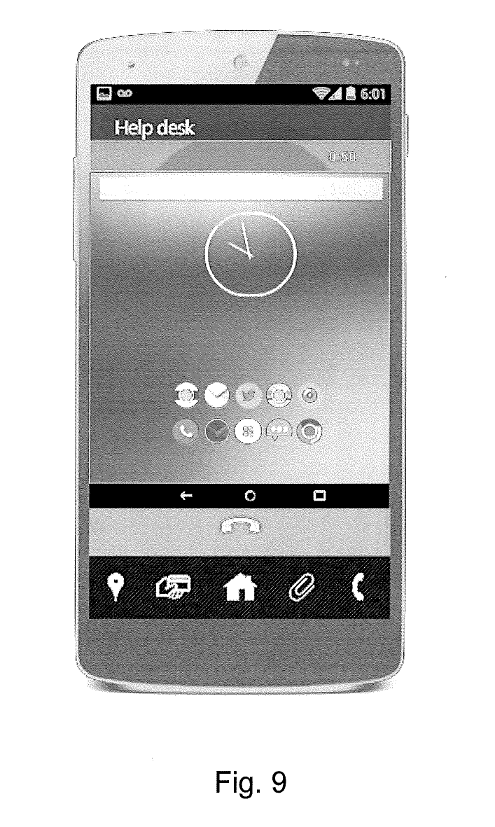

Share screen may be accessed to provide the same display window information simultaneously in both communication devices. For example, this may be used to share the ordinary user interface of the communication device during navigation, e.g. when trying to find a certain item, when getting help from a help desk, and the like. Such a mode is shown schematically in FIG. 9

Browser may be accessed to provide a common browser screen on both communication devices. This may e.g. be used during a telephone conference where information on a web page is to be discussed, or when two parties are together, during a call session, trying to find a certain item on a purchasing site.

Whiteboard may be used to access a common drawing area, in which illustrations can be drawn during the call session, and which are shared between both communication devices.

Further options are possible. For example, there may be a button or menu item related to health data and other sensor data accessible by one of the communication devices, and which may then be forwarded to the other party. This is e.g. very useful when calling a medical facility, an alarm central, etc.

The telephone button may be provided to get access to conventional functions and tools found in ordinary telephone applications, such as possibilities to control the sound, speakers, parking of a call, adding of further parties to a multi-party call, etc. This button may also get access to contact lists and phone books.

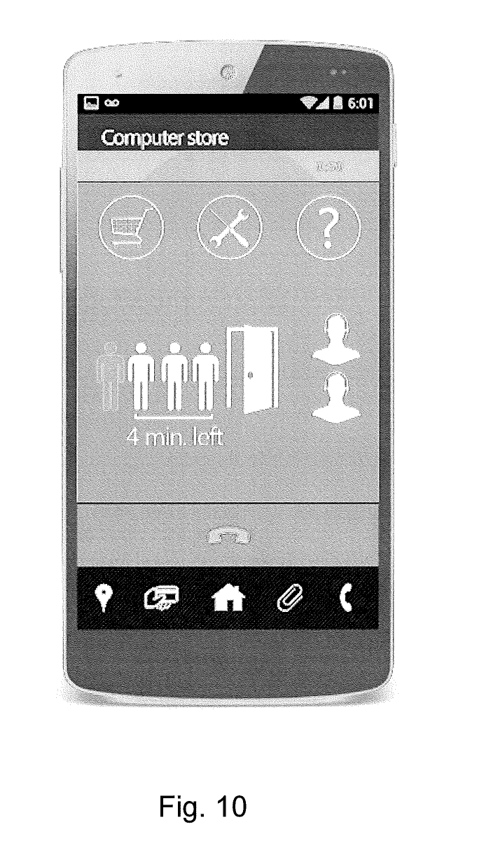

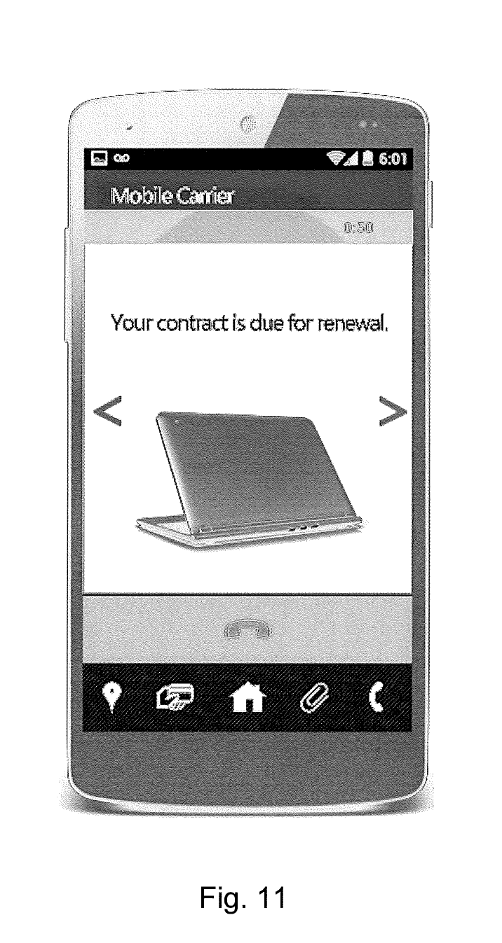

As have been discussed in the foregoing, the receiving party may provide a standardized or customized display page to the calling party. For example, as illustrated in FIG. 10, a store may provide a display page informing about estimated remaining queue time, and provide various searching options, current offers that may be of interest, etc. Similarly, as shown in FIG. 11, the customer may be shown personal information and details, such as information about the need for renewal of a contract. This facilitates the contacts, and makes the communication more efficient.

The person skilled in the art realizes that the present invention by no means is limited to the preferred embodiments described above. On the contrary, many modifications and variations are possible within the scope of the appended claims.

1-19. (canceled)

20. A method for providing context based commercial information, comprising:
establishing a voice communication session between a first party using a mobile communication device and at least one other party using a remote communication device via a communications network;
receiving information associated with the voice communication session at a remote server, said information comprising at least identification data of the parties participating in the voice communication session and audio data associated with the communication session;
storing said received information at a remote server in a profile associated with at least one of said parties, wherein said profile is updated at each new voice communication session;
analyzing said stored information in said profile;
generating, based on said analyzed information, customized commercial information; and
sending said generated customized commercial information to the mobile communication device.

21. The method according to claim 20, further comprising storing said received information in a corresponding local profile on the communication device associated with said at least one of said parties.

22. The method according to claim 20, wherein said voice communication session is a video communication session comprising both audio and video transfer.

23. The method according to claim 21, further comprising combining said stored information with data from a third party also associated with said profile.

24. A system for providing user customized commercial information, said system comprises:
means for establishing a voice communication session between a first party using a mobile communication device and at least one other party using a remote communication device via a communications network;
means for establishing a data communication session while maintaining the voice communication session;
server means for receiving information associated with said voice communication session, the information comprising at least identification data of the parties participating in said communication session and audio data associated with the voice communication session;
means for storing said information in a database together with a profile associated with at least one of said parties, and wherein said stored information is updated at each new voice communication session; and
said stored information being useable to generate customized commercial information for at least one of the parties participating in said communication session after termination of said communication session.

25. The system according to claim 24, further comprising means for storing said received information in a corresponding local profile on the communication device associated with said at least one of said parties.

26. The system according to claim 24, wherein said voice communication session is a video communication session comprising both audio and video transfer.

27. The system according to claim 25, wherein said stored information is combined with data from a third party also associated with said profile.

28. A software application for a mobile communication device, residing on a computer-readable medium and comprising computer program code for:
establishing a voice communication session between a first party using said mobile communication device and at least one other party using a remote communication device via a communications network, the voice communication session being established with said at least one other party utilizing a phone number associated with the at least one other party;
sending information associated with said voice communication session to a remote server, said information comprising at least identification data of the parties participating in the voice communication session and audio data associated with the voice communication session, storing said information associated with said voice communication session in a general file, wherein said general file is updated at each new voice communication session;
said general file being used to generate customized commercial information for the parties participating in said voice communication session after termination of said voice communication session; and
receiving said customized commercial information in said mobile communication device after termination of said voice communication session.

29. The software application according to claim 28, further comprising means for transferring data between the parties participating in the voice communication session while maintaining the voice communication session.

30. The software application according to claim 29, wherein data is visually presented in an interface window of the voice communication session in the mobile communication device.

31. The software application according to claim 28, further comprising means for establishing a data communication session between a mobile communication device and a remote device with network capabilities and controlling said remote device.

32. The software application according to claim 28, further comprising means for gathering health data from sensors within the mobile communication device or external sensors accessible by the mobile communication device, and sending the gathered health data to the at least one other party participating in the voice communication session.

33. The software application according to claim 28, further comprising means for automatically sending data from the mobile communication device to the at least one other party participating in the voice communication session when the phone number associated with the at least one other party is an emergency phone number.

34. The software application according to claim 28, wherein said audio data is used in combination with other data associated with at least one of the parties associated with the voice communication session to generate said customized commercial information.

35. The software application according to claim 28, further comprising means for creating a call page associated with a profile for display during a voice communication session.

36. The software application according to claim 20, wherein the mobile communication device is a smart-phone.

37-40. (canceled)
